(19) United States
(12) Patent Application Publication
(10) Pub. No.: US 2021/0116968 A1
(43) Pub. Date: Apr. 22, 2021

(54) FLEXIBLE PROTECTIVE COVER AND DISPLAY DEVICE

(71) Applicant: Wuhan China Star Optoelectronics Semiconductor Display Technology Co.,LTD, Wuhan, Hubei (CN)

(72) Inventors: Chunmei HE, Wuhan, Hubei (CN); Bao Chen, Wuhan, Hubei (CN); Bao Chen, Wuhan, Hubei (CN)

(21) Appl. No.: 16/957,755

(22) PCT Filed: Sep. 20, 2019
(86) PCT No.: PCT/CN2019/107024

§ 371 Date: Jun. 25, 2020

(30) Foreign Application Priority Data
Jul. 31, 2019 (CN) 201910699335..X

(51) Int. Cl. G06F 1/16; B32B 27/08

(52) U.S. Cl. CPC G06F 1/1652; B32B 27/08; B32B 2255/20; B32B 2307/412; B32B 2307/732; B32B 2457/20

(57) ABSTRACT

A flexible protective cover for attaching to a display panel, the flexible protective cover includes at least two hard coating layers and a transparent layer disposed between two adjacent hard coating layers. Since a modulus of the hard coating layers is greater than a modulus of the transparent layer, a hardness of the flexible protective cover can be significantly increased. It has been verified by simulation calculation that the flexible protective cover of the present disclosure has a hardness increase of 8% while maintaining same flexibility and bending resistance, as compared with the conventional flexible cover.

### FIELD OF INVENTION

The present disclosure relates to the field of display technology, and more particularly, to a flexible protective cover and a display device.

### BACKGROUND OF INVENTION

Folding mobile phone is the future trend of technological development. The key component of developing the folding mobile phone is a flexible cover, which is equivalent to a 3D glass cover for protecting the screen.

Currently, due to immature bending technology of glass cover, transparent polyimide with hard coating material is currently the mainstream development direction. As shown in FIG. 1, which shows a conventional flexible cover 1, the flexible cover 1 includes a transparent polyimide layer 2 and a hard coating layer 3. In the flexible cover 1 shown in FIG. 1, a hardness of the flexible cover 1 is usually adjusted by changing a thickness of the hard coating layer 3.

In the flexible cover 1 which is shown in FIG. 1, when a hard coating layer 3 is thicker, a hardness of the flexible cover 1 is greater, but fracture will occur during bending. When a thickness of the hard coating layer 3 is decreased, flexibility of the flexible cover 1 is increased, but there is a problem of insufficient hardness. Therefore, a hardness of the conventional flexible cover 1 shown in FIG. 1 is mutually limited by a flexibility, and cannot be perfectly balanced.

Therefore, it is necessary to provide a new flexible cover to overcome the above problems.

### SUMMARY OF INVENTION

The object of the present disclosure is to provide a flexible protective cover by disposing a hard coating layer to significantly increased a hardness of the flexible protective cover.

To achieve the above object, the present disclosure provides a flexible protective cover, including at least two hard coating layers and at least one transparent layer, wherein each of the transparent layer disposed between two adjacent hard coating layers of the at least two hard coating layers, wherein a sum of thicknesses of all the at least two hard coating layers is less than or equal to 20 μm; and material of the at least two hard coating layers interposed between two adjacent transparent layers of the at least one transparent layer is selected from the group consisting of a silicon nitride, a silicon oxide, a silicon nitride doped organic material, or a silicon oxide doped organic material.

According to another aspect of the present disclosure, the present disclosure provides a flexible protective cover for attaching to a display panel, the flexible protective cover includes at least two hard coating layers and a transparent layer disposed between adjacent two hard coating layers. Thus, in the flexible protective cover of the present disclosure, the hard coating layer and the transparent layer are alternately disposed, and the hard coating layer serves as a surface of the flexible protective cover. That is, a top layer and bottom layer of the flexible protective cover which exhibiting a multilayer structure, are both hard coating layers.

In an embodiment, the flexible protective cover includes a first hard coating layer, a first transparent layer, and a second hard coating layer which are stacked sequentially.

In an embodiment, material of at least one of the hard coating layer is selected from the group consisting of a silicon nitride, a silicon oxide, a silicon nitride doped organic material, or a silicon oxide doped organic material. For example, material of at least one of the first hard coating layer and the second hard coating layer is selected from the group consisting of a silicon nitride, a silicon oxide, a silicon nitride doped organic material, or a silicon oxide doped organic material.

In an embodiment, the flexible protective cover including a second transparent layer disposed on the second hard coating layer, and a third hard coating layer disposed on the second transparent layer. Preferably, material of the second hard coating layer is selected from the group consisting of a silicon nitride, a silicon oxide, a silicon nitride doped organic material, or a silicon oxide doped organic material.

In an embodiment, a sum of thicknesses of all the at least two hard coating layers is less than or equal to 20 μm. For example, when the flexible protective cover includes two hard coating layers, a first hard coating layer and a second hard coating layer, a sum of a thickness of the first hard coating layer and a thickness of the second hard coating layer is less than or equal to 20 μm. When the flexible protective cover includes three hard coating layers, that is a first hard coating layer, a second hard coating layer, and a third hard coating layer, a sum of a thickness of the first hard coating layer, a thickness of the hard coating layer, and a thickness of the third hard coating layer is less than or equal to 20 μm, and so on.

In an embodiment, a sum of thicknesses of all hard coating layers is less than or equal to 80 μm. For example, when the flexible protective cover includes a transparent layer, that is a first transparent layer, then a thickness of the first transparent layer is less than or equal to 80 μm, when the flexible protective cover includes two transparent layer, that is a first transparent layer and a second transparent layer, then a sum of the thickness of the first transparent layer and the thickness of the second transparent layer is less than or equal to 80 μm, and so on.

In an embodiment, a sum of thicknesses of all hard coating layers may range from 1 μm to 20 μm. For example, the sum of thicknesses of the hard coating layers may be but not limited to: 2 μm, 4 μm, 6 μm, 8 μm, 10 μm, 12 μm, 14 μm, 16 μm, 18 μm, or 20 μm. For example, when the flexible protective cover includes two hard coating layers, namely a first hard coating layer and a second hard coating layer, a sum of the thickness of the first hard coating layer and the thickness of the second hard coating layer may be but not limited to: 2 μm, 4 μm, 6 μm, 8 μm, 10 μm, 12 μm, 14 μm, 16 μm, 18 μm, or 20 μm. When the flexible protective cover includes three hard coating layers, ie, a first hard coating layer, a second hard coating layer, and a third hard coating layer, a sum of a thickness of the first hard coating layer, a thickness of the second hard coating layer, and a thickness of the third hard coating layer may be but not limited to: 2 μm, 4 μm, 6 μm, 8 μm, 10 μm, 12 μm, 14 μm, 16 μm, 18 μm, or 20 μm.

In an embodiment, a sum of thickness of all transparent layers may range from 1 μm to 80 μm. The sum of thicknesses of all transparent layers may be but not limited to: 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, or 80 μm. For example, when the flexible protective cover includes a transparent layer, a first transparent layer, then a thickness of the first transparent layer can be but not limited to: 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, or 80 μm.

In an embodiment, each of the hard coating layers has same thickness, and each of the transparent layers has same thickness.

In an embodiment, a material of the transparent layer is at least one of a transparent polyimide, a polyethylene terephthalate (PET), a polyethylene naphthalate (PEN), or a polymethyl methacrylate (PMMA).

It will be understood by those skilled in the art that the hard coating layer or the first hard coating layer described herein is made of materials known in the art, such as, but not limited to, coating of nano inorganic particles (such as SiO2), silica organic-inorganic composite composition, etc., and the like.

According to another aspect of the present disclosure, which provides a flexible protective cover including at least one first hard coating layer and at least one second hard coating layer, and a transparent layer disposed between the first hard coating layer and the second hard coating layer, wherein the transparent layer disposed between the hardened coating layers; wherein a material of the second hard coating layer is selected from the group consisting of a silicon nitride, or a silicon oxide.

In an embodiment, the flexible protective cover includes a first hard coating layer, a first transparent layer disposed on the first hard coating layer, and a second hard coating layer disposed on the transparent layer. Preferably, the flexible protective cover further includes a second transparent layer disposed on the second hard coating layer, and a second layer of the first hard coating layer disposed on the transparent layer.

According to another aspect of the present disclosure, which provides a display device including a display panel and a flexible protective cover described above, wherein the flexible protective cover is disposed on a side of the display panel. In particular, the flexible protective cover is disposed on a display side of the display panel.

In an embodiment of the present disclosure, the hard coating layer of the flexible protective cover covers and contacts a side of the display panel. Particularly, the hard coating layer of the flexible protective cover covers and contacts the display side of the display panel.

In an embodiment of the present disclosure, the display is a flexible display panel.

In a preferable embodiment of the present disclosure, which provides a display device including a display panel and a flexible protective cover disposed on a side of the display panel, wherein the flexible protective cover includes at least two hard coating layers and a transparent layer disposed between the two adjacent hard coating layers, each of the hard coating layer is alternately disposed with each of the transparent layer, and the hard coating layer covers and contacts on a display side of the display panel.

In a preferable embodiment of the present disclosure, which provides a display device including a display panel and a flexible protective cover disposed on a side of the display panel, wherein the flexible protective cover includes a first hard coating layer, a first transparent layer, a second hard coating layer, a second transparent layer, and a third hard coating layer which are cascaded disposed sequentially, a material of the second hard coating layer is selected from the group consisting of a silicon nitride, a silicon oxide, a silicon nitride doped organic material, or a silicon oxide doped organic material.

In the above embodiment, a sum of the thickness of the first hard coating layer, is the thickness of the second hard coating layer, and the thickness of the third hard coating layer is less than or equal to 20 μm; and a sum of the thickness of the first transparent layer and the thickness of the second transparent layer is less than or equal to 80 μm. Preferably, the first hard coating layer, the second hard coating layer, and the third hard coating layer has same thickness, and the first transparent layer and the second transparent layer has same thickness.

In the above embodiment, a material of the transparent layer is at least one of a transparent polyimide, a polyethylene terephthalate, a polyethylene naphthalate, or a polymethyl methacrylate.

In the flexible protective cover of the present disclosure, since a modulus of the hard coating layer is greater than a modulus of the transparent layer, a hardness of the flexible protective cover can be significantly increased. It has been verified by simulation calculation that the flexible protective cover of the present disclosure has a hardness increase of 8% while maintaining the same flexibility and bending resistance, as compared with the conventional flexible cover.

### DESCRIPTION OF DRAWINGS

In order to more clearly illustrate the technical solutions in the embodiments of the present disclosure, the figures used in the description of the embodiments will be briefly described below. It is obvious that the figures in the following description are only some embodiments of the present disclosure. Other figures can also be obtained from those skilled in the art based on these figures without any inventive step.

FIG. 1 is a schematic structural diagram of a conventional flexible cover.

FIG. 2 is a schematic structural diagram of a flexible protective cover according to an embodiment of the present disclosure.

FIG. 3A is a sinking amount obtained by simulation analysis of a conventional flexible cover by nanoindentation simulation.

FIG. 3B is a sinking amount obtained by simulation of the flexible protective cover as shown in FIG. 2 by nanoindentation simulation.

FIG. 4 is a schematic structural diagram of a flexible protective cover according to another embodiment of the present disclosure.

FIG. 5 is a schematic structural diagram of a display device according to an embodiment of the present disclosure.

### DETAILED DESCRIPTION OF PREFERRED EMBODIMENTS

The embodiments of the present disclosure are described in detail below, and the examples of the embodiments are illustrated in the figures, wherein the same or similar reference numerals are used to refer to the same or similar components or components having the same or similar functions. The embodiments described below with reference to the figures are intended to illustrative the disclosure and are not to be construed as limiting.

In the present disclosure, unless specifically defined, the first feature “on” or “under” the second feature may include direct contact of the first and second features, and may also include not in direct but through additional features to contact between the first feature and second feature. Moreover, the first feature “above”, “on” and “upon” the second feature includes the first feature directly above and on the second feature, or merely indicating that the first feature level is higher than the second feature. The first feature “below”, “under” and “beneath” the second feature includes the first feature directly below and under the second feature, or merely the first feature level being less than the second feature.

The following disclosure provides many different embodiments or examples for implementing different structures of the present disclosure. In order to simplify the disclosure of the present disclosure, the components and arrangements of the specific examples are described below. Of course, they are merely examples and are not intended to limit the present disclosure. In addition, the present disclosure may be repeated with reference to the numerals and/or reference numerals in the various examples, which are for the purpose of simplicity and clarity, and do not indicate the relationship between the various embodiments and/or arrangements discussed. Moreover, the present disclosure provides examples of various specific processes and materials, but one of ordinary skill in the art will recognize the use of other processes and/or the use of other materials.

### Embodiment 1. Flexible Protective Cover 100

In this embodiment, a flexible protective cover 100 is provided. As shown in FIG. 2, the flexible protective cover 100 includes three hard coating layers 101 and two transparent layers 102, wherein each of the hard coating layers 101 is alternately disposed with each of the transparent layers 102. That is, in this embodiment, a bottom layer and a top layer of the flexible protective cover 100 are both hard coating layers 101, and a hard coating layer 101 is interposed between the bottom layer and the top layer of the flexible protective cover 100. Each of the transparent layers 102 is interposed between the two adjacent hard coating layers 101, and thus forming a stacked structure in which the hard coating layers 101 and the transparent layers 102 are alternately arranged as shown in FIG. 2.

In this embodiment, a material of the hard coating layers 101 includes a hardened coating (or hardened layer) material known in the art, such as, but not limited to, a coating comprising nano inorganic particles (such as SiO2), or a silica organic-inorganic composite composition, and the like. A material of the transparent layers 102 is a transparent polyimide.

In this embodiment, a sum of thicknesses of the hard coating layers 101 is less than 20 μm, such as but not limited to: 2 μm, 4 μm, 6 μm, 8 μm, 10 μm, 12 μm, 14 μm, 16 μm, 18 μm, 20 μm. In this embodiment, a sum thickness of all the transparent layers 102 is less than 80 μm, such as but not limited to: 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, and 80 μm. Preferably, each of the at least two hard coating layers 101 has the same thickness, and each of the at least one transparent layer 102 has the same thickness.

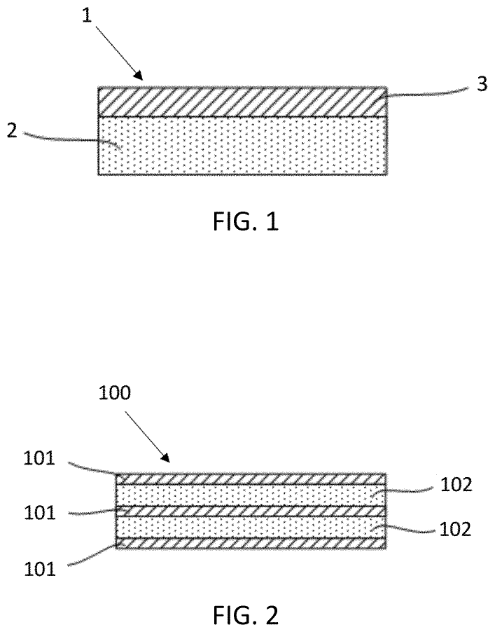

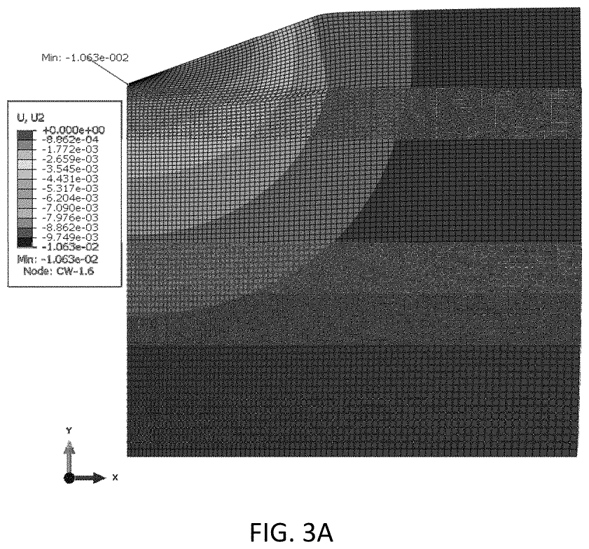

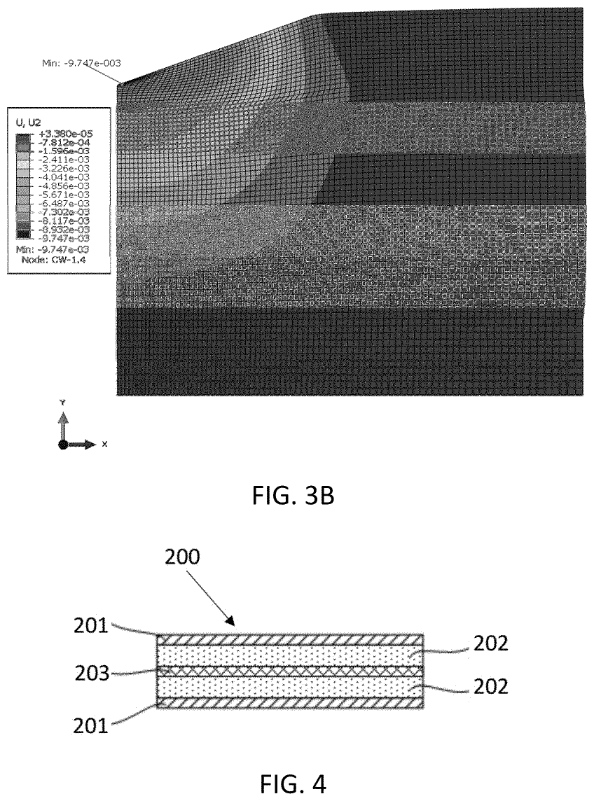

In order to verify the performance of the flexible protective cover 100 of this embodiment, depression depths of the flexible protective cover 100 of this embodiment and the conventional flexible cover 1 of FIG. 1 are respectively calculated, obtaining an amount of sinking of the conventional flexible cover 1 shown in FIG. 3A and an amount of sinking of the flexible protective cover 100 shown in FIG. 3B. In this embodiment, a hardness of the flexible protective cover 100 (or the flexible cover 1) is characterized by the amount of sinking of the flexible protective cover 100 (or the flexible cover 1). It is calculated that, as shown in FIG. 3A and FIG. 3B, the amount of sinking of the flexible protective cover 100 of the present embodiment is reduced by 8% compared with the amount of sinking of the flexible cover 1 shown in FIG. 1 The flexible protective cover 100 is described in the example has a better hardness feature.

### Embodiment 2. Flexible Protective Cover 200

In this embodiment, a flexible protective cover 200 is provided. As shown in FIG. 4, the flexible protective cover 200 includes a first hard coating layer 201, a first transparent layer 202 disposed on the first hard coating layer 201, a second hard coating layer 203 disposed on the transparent layer 202, a second transparent layer 202 disposed on the second hard coating layer 203, and a second layer of the first hard coating layer 201 disposed on the transparent layer 202.

In this embodiment, a material of the first hard coating layers 201 includes a hardened coating (or hardened layer) material known in the art, such as, but not limited to, a coating comprising nano inorganic particles (such as SiO2), or a silica organic-inorganic composite composition, and the like. A material of the transparent layers 102 is a transparent polyimide. A material of the second hard coating layer 201 includes a silicon nitride, a silicon oxide, or a silicon oxide doped organic material.

Obviously, in this embodiment, a main difference between the flexible protective cover 200 and the flexible protective cover 100 of embodiment 1 is that the material of the intermediate hard coating layer (i.e., the second hardened coating layer 201) consists of a silicon nitride, a silicon oxide, or a silicon oxide doped organic materials.

In this embodiment, a sum of thicknesses of the first hard coating layers 201 and the second hard coating layer 202 is less than 20 μm, such as but not limited to: 2 μm, 4 μm, 6 μm, 8 μm, 10 μm, 12 μm, 14 μm, 16 μm, 18 μm, and 20 μm. In this embodiment, a sum of thicknesses of all of the transparent layers 202 is less than 80 μm. Preferably, each of the first hard coating layers 201 has a same thickness, such as but not limited to: 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, and 80 μm. Meanwhile, a thickness of the second hard coating layer 203 is same as the thickness of the first hard coating layers 201; and each of the transparent layers 202 has same thickness.

Similar to the embodiment 1, in order to verify the performance of the flexible protective cover 200 of this embodiment, a depression depth of the flexible protective cover 200 of this embodiment is calculated by simulation of nanoindentation, characterizing a hardness of the flexible protective cover 200 by an amount of sinking of the flexible protective cover 200. Through the calculation, compared to the flexible protective cover 100 of the embodiment 1, an amount of depression of the flexible protective cover 200 of this embodiment is reduced by 8%; and compared to the conventional flexible cover as shown in FIG. 1, the amount of depression of the flexible protective cover 200 described in this embodiment is reduced by 16%. Obviously, the flexible protective cover 200 described in this embodiment has a better hardness feature.

### Embodiment 3. Display Device

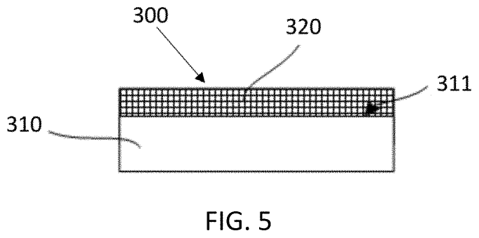

In this embodiment, a display device 300 is provided. As shown in FIG. 5, the display device 300 includes a display panel 310 and a flexible protective cover 320. The display panel 310 is a flexible display panel, and may be a flexible OLED display panel or a flexible liquid crystal display panel. It can be understood by those skilled in the art that the display panel 310 has a structure known in the art, and can also have a touch layer (not shown) on one side 311 to form a touch display panel. The flexible protective cover 320 is disposed on the side 311 of the display panel 310. It can be understood by those skilled in the art that the side 311 is specifically a display side of the display panel 310. In addition, a person skilled in the art can understand that when the side 311 further has a touch layer to form a touch display panel, the flexible protective cover 320 is disposed on the touch layer for protection.

The flexible protective cover 320 may have a same structure as the flexible protective cover 100 described in the embodiment 1, and may have a same structure as the flexible protective cover 200 described in the embodiment 2, and details are not described herein again.

The present disclosure has been described by the above related embodiments, but the above embodiments are merely examples for implementing the present disclosure. It must be noted that the disclosed embodiments do not limit the scope of the disclosure. Rather, modifications and equivalent arrangements are intended to be included within the scope of the appended claims.

### INDUSTRIAL APPLICABILITY

The main body of the present disclosure can be manufactured and used in the industry, and has industrial applicability.

What is claimed is:

1. A flexible protective cover, comprising at least two hard coating layers and at least one transparent layer, wherein each of the at least one transparent layer disposed between two adjacent hard coating layers of the at least two hard coating layers, wherein
a sum of thicknesses of all the at least two hard coating layers is less than or equal to 20 μm; and
a material of the at least two hard coating layers interposed between two adjacent transparent layers is selected from the group consisting of a silicon nitride, a silicon oxide, a silicon nitride doped organic material, or a silicon oxide doped organic material.

2. The flexible protective cover as claimed in claim 1, further comprising a first hard coating layer, a first transparent layer, and a second hard coating layer which are stacked, wherein a material of at least one of the first hard coating layer or the second hard coating layer is selected from the group consisting of a silicon nitride, a silicon oxide, a silicon nitride doped organic material, or a silicon oxide doped organic material.

3. The flexible protective cover as claimed in claim 2, further comprising a second transparent layer disposed on the second hard coating layer, and a third hard coating layer disposed on the second transparent layer, wherein a material of the second hard coating layer is selected from the group consisting of a silicon nitride, a silicon oxide, a silicon nitride doped organic material, or a silicon oxide doped organic material.

4. The flexible protective cover as claimed in claim 1, wherein a material of the at least one transparent layer comprises a transparent polyimide, a polyethylene terephthalate, a polyethylene naphthalate, or a polymethyl methacrylate.

5. The flexible protective cover as claimed in claim 1, wherein a sum of thicknesses of all the at least one transparent layer is less than or equal to 80 μm.

6. The flexible protective cover as claimed in claim 1, wherein each of the at least one transparent layer has same thickness.

7. The flexible protective cover as claimed in claim 1, wherein each of the at least two hard coating layers has same thickness.

8. A flexible protective cover for attaching to a display panel, wherein the flexible protective cover comprises at least two hard coating layers and at least one transparent layer disposed between two adjacent hard coating layers of the at least two hard coating layers, each of the at least two hard coating layers is alternately disposed with each of the at least one transparent layer.

9. The flexible protective cover as claimed in claim 8, further comprising a first hard coating layer, a first transparent layer, and a second hard coating layer which are stacked.

10. The flexible protective cover as claimed in claim 9, further comprising a second transparent layer disposed on the second hard coating layer, and a third hard coating layer disposed on the second transparent layer.

11. The flexible protective cover as claimed in claim 8, a sum of thicknesses of all the at least two hard coating layers is less than or equal to 20 μm, and a sum of thicknesses of all the at least one transparent layer is less than or equal to 80 μm.

12. The flexible protective cover as claimed in claim 8, wherein each of the at least one transparent layer has same thickness, each of the at least two hard coating layers has same thickness.

13. The flexible protective cover as claimed in claim 8, wherein material of the at least two hard coating layers interposed between two adjacent transparent layers of the at least one transparent layer is selected from the group consisting of a silicon nitride, a is silicon oxide, a silicon nitride doped organic material, or a silicon oxide doped organic material.

14. The flexible protective cover as claimed in claim 1, wherein a material of the transparent layer is a transparent polyimide, a polyethylene terephthalate, a polyethylene naphthalate, or a polymethyl methacrylate.

15. A display device, comprising a display panel and the flexible protective cover as claimed in claim 1, wherein the flexible protective cover is disposed on a side of the display panel.

16. The display device as claimed in claim 15, wherein the flexible protective cover is disposed on a display side of the display panel.

17. The display device as claimed in claim 16, wherein the at least two hard coating layers of the flexible protective cover and contact the display side of the display panel.

18. The display device as claimed in claim 15, wherein the flexible protective cover further comprises a first hard coating layer, a first transparent layer, a second hard coating layer, a second transparent layer, and a third hard coating layer, which are cascaded and disposed sequentially, and a material of the second hard coating layer is selected from the group consisting of a silicon nitride, a silicon oxide, a silicon nitride doped organic material, or a silicon oxide doped organic material.

19. The display device as claimed in claim 18, wherein the first hard coating layer of the flexible protective cover covers and contacts the display side of the display panel.

20. The display device as claimed in claim 15, wherein the display panel is a flexible display panel.
